(19) United States
(12) Patent Application Publication
(10) Pub. No.: US 2013/0036357 A1
(43) Pub. Date: Feb. 7, 2013

(54) SYSTEMS AND METHODS FOR AUTOMATICALLY SWITCHING ON AND OFF A "SCROLL-ON OUTPUT" MODE

(71) Applicant: Kenneth J. Hendrickson, Melbourne, FL (US)

(72) Inventor: Kenneth J. Hendrickson, Melbourne, FL (US)

(73) Assignee: HARRIS CORPORATION, Melbourne, FL (US)

(21) Appl. No.: 13/197,378

(22) Filed: Aug. 3, 2011

(51) Int. Cl. G06F 3/048; G06F 3/16

(52) U.S. Cl. 715/728; 715/784; 715/786

(57) ABSTRACT

Systems and methods for automatically controlling “scroll-on output” (“SOO”) operations of a computing device (100). The methods involve: adding First Display Content (“FDC”) to a display (304); receiving a First User Input (“FUI”) for scrolling back FDC (706); determining if the SOO operations are enabled in response to the reception of FUI; and automatically disabling the SOO operations if it is determined that the SOO operations are enabled. The methods also involve: receiving a Second User Input (“SUI”) for scrolling forward the FDC; determining if the SOO operations are enabled in response to the reception of SUI; and automatically enabling the SOO operations if it is determined that the SOO operations are disabled.

### BACKGROUND OF THE INVENTION

1. Statement of the Technical Field

The invention concerns computing systems. More particularly, the invention concerns computing systems and methods for automatically switching “on” and “off” a “scroll-on output” mode in response to the scrolling of content displayed in a display.

2. Description of the Related Art

There are many computing systems known in the art. Such computing systems include, but are not limited to, personal computers. Users interact with the computing systems via Graphical User Interfaces (“GUIs”), input devices (e.g., a keyboard, a mouse, a display screen and a microphone) and output devices (e.g., a display screen and speakers). The GUIs facilitate the scrolling of documents (e.g., data files, word processing documents, e-mail documents, images, and Internet web pages), video clips, messaging conversations and graphs. The term “scrolling” is generally understood by persons skilled in the art to mean the sliding of text, images or video across a monitor or display in horizontal and/or vertical directions. “Scrolling” does not change the layout of the text, images, video or graphs, but incrementally moves the user's view across a larger document, list, image, video clip or graph that is not wholly seen in a computer display, window or viewport. A viewport is a framed area on a display screen for viewing information. “Scrolling” is typically achieved using a scrollbar of a GUI, a scroll wheel of a computer mouse, a scroll ball of a computer mouse, or arrow keys of a keyboard.

The scrolling features of the computing systems may be enabled/disabled by a user via a scroll lock key of a keyboard. The scroll lock key is a key of a keyboard that is configured to turn “on” and “off” a scroll lock mode of a computing system. When the scroll lock mode is “on”, the arrow keys of the keyboard can be used to scroll the contents of a window. Also, a “scroll-on output” function is enabled so that the contents of the window are automatically scrolled when new data is received at or by the computing system. When the scroll lock mode is “off”, the arrow keys of the keyboard cannot be used to scroll contents of a window. Also, the “scroll-on output” function is disabled.

Today, the above described use of the scroll lock key is rare. Only a few modern programs still honor the above-described behavior of the scroll lock key. In this regard, it should be noted that the scroll lock key is now typically used to provide other functions such as switching lights “on” and “off”, pausing screen output, toggling a listening mode for voice recognition programs, locking use of a mouse or keyboard function, opening a menu or changing between different languages.

The scrolling features of the computing systems may also be enabled/disabled by a user via a command presented within a menu of an application window. For example, scrolling on a keystroke is enabled and disabled by clicking on a symbol or text presented by a menu bar of a GUI. By clicking on the symbol or text, the user is selecting the instruction that the symbol represents, i.e., enable or disable scrolling on a keystroke. Similarly, the above-described “scroll-on output” function is enabled and disabled by clicking on a symbol or text presented by the menu bar of the GUI.

The scrolling features of the computing systems may further be enabled/disabled by a user via the selection of a checkbox presented in a configuration window. For example, scrolling on a keystroke is enabled and disabled by clicking on a checkbox associated with the caption “Scroll-on keystroke”. Similarly, the above-described “scroll-on output” function is enabled or disabled by clicking on the checkbox associated with the caption “Scroll-on output” or “Disable scrollback”. The configuration window may also include GUI widgets for allowing the user to specify the placement of the scroll bar within a GUI and the maximum number of scroll back lines.

Notably, users of the above-described conventional computing systems are undesirably required to navigate to menus or configuration windows to change the scrolling behaviors of computing systems. Also, if the above-described “scroll-on output” function is enabled, then a current manually scrolled back screen position is lost when new data is received at or by a computing system. In order to assist a reader in understanding this statement, an instant messaging scenario is discussed. If a user is participating in an instant messaging conversation and he scrolls back to see a previous part of the messaging conversation, then his screen position is automatically changed when new text data is received from another party participating in the messaging conversation. The screen position is changed so that the new text data is seen on the messaging chat window, i.e., the user's view is moved forward in the messaging chat window. As such, the user's scrolled back screen position is lost. Consequently, the user must manually scroll back again to find the previous part of the messaging conversation that he was viewing prior to the reception of the new text data.

### SUMMARY OF THE INVENTION

Embodiments of the present invention concern implementing systems and methods for automatically enabling and disabling “scroll-on output” operations of a computing device. Method embodiments involve receiving a user input for enabling automatic “scroll-on output” mode on/off switching operations. These automatic “scroll-on output” mode on/off switching operations generally include: automatically disabling the “scroll-on output” operations when scrolling is used by a user to view a previously displayed output; and automatically enabling the “scroll-on output” operations when scrolling is used by the user to view a most recently displayed output.

Embodiments of the present invention also concern devices comprising computer-readable storage mediums. Each of the computer-readable storage mediums has stored thereon a computer program for enabling and disabling “scroll-on output” operations. The computer program has a plurality of code sections. In embodiments of the present invention, the code sections are executable by a computer to cause the computer to perform the steps of: adding first display content to a display; receiving a first user input for scrolling back the first display content so as to be able to view a first portion of the first display content which is not currently visible within the display; and performing subsequent operations in response to the reception of the first user input. The subsequent operations include: determining if the “scroll-on output” operations are enabled; and automatically disabling the “scroll-on output” operations if it is determined that the “scroll-on output” operations are enabled. The code sections are also configured to cause the computer to perform the steps of: receiving a second user input for scrolling forward the first display content so as to be able to view a second portion of the first display content which is not currently visible within the display; and performing additional operations in response to the reception of the second user input.

### BRIEF DESCRIPTION OF THE DRAWINGS

Embodiments will be described with reference to the following drawing figures, in which like numerals represent like items throughout the figures, and in which:

FIG. 1 is a block diagram of an exemplary computing device that is useful for understanding the present invention.

FIGS. 2A-2C collectively provide a flow diagram of an exemplary method for automatically switching “on” and “off” a “scroll-on output” mode that is useful for understanding the present invention.

FIG. 3 is a schematic illustration of an exemplary window displayed on a display screen that is useful for understanding the present invention.

FIG. 4 is a schematic illustration of an exemplary GUI element for enabling an Automatic Scroll-On Output on/off Switching (“ASOOS”) function that is useful for understanding the present invention.

FIG. 5 is a schematic illustration of an exemplary menu for facilitating the enablement of the ASOOS function that is useful for understanding the present invention.

FIG. 6 is a schematic illustration of an exemplary configuration window for facilitating the enablement of the ASOOS function that is useful for understanding the present invention.

FIG. 7 is a schematic illustration of the window of FIG. 1 with exemplary first content displayed therein that is useful for understanding the present invention.

FIG. 8 is a schematic illustration of the window of FIG. 1 whose content has been automatically scrolled such that exemplary second content is seen by a user.

FIG. 9 is a schematic illustration of the window of FIG. 1 whose content has been scrolled back in response to a user input.

FIG. 10 is a schematic illustration of the window of FIG. 1 whose content has been scrolled forward in response to a user input.

FIG. 11 is a schematic illustration of the window of FIG. 1 whose content has been automatically scrolled forward such that new content is displayed in the window.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The present invention concerns implementing systems and methods for automatically enabling and disabling “scroll-on output” operations or a “scroll-on output” mode of a computing device. Notably, the present invention overcomes various drawbacks of conventional computing systems. For example, the present invention provides a GUI widget means within an application window for enabling and disabling automatic “scroll-on output” mode on/off switching operations. As such, users of the present invention are not required to navigate to menus or configuration windows to change the scrolling behaviors of computing systems. Also, the automatic “scroll-on output” mode on/off switching operations ensure that a current manually scrolled back screen position is not lost when new data is received at or by a computing system. The automatic “scroll-on output” mode on/off switching operations generally include: automatically disabling the “scroll-on output” operations or the “scroll-on output” mode when scrolling is used by a user to view a previously displayed output; and automatically enabling the “scroll-on output” operations or the “scroll-on output” mode when scrolling is used by the user to view a most recently displayed output.

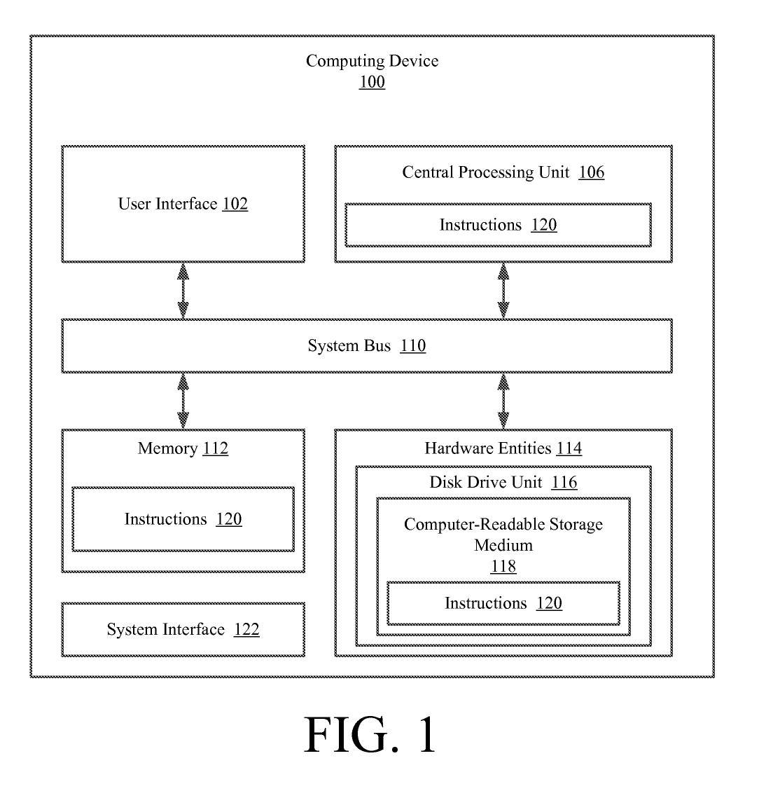

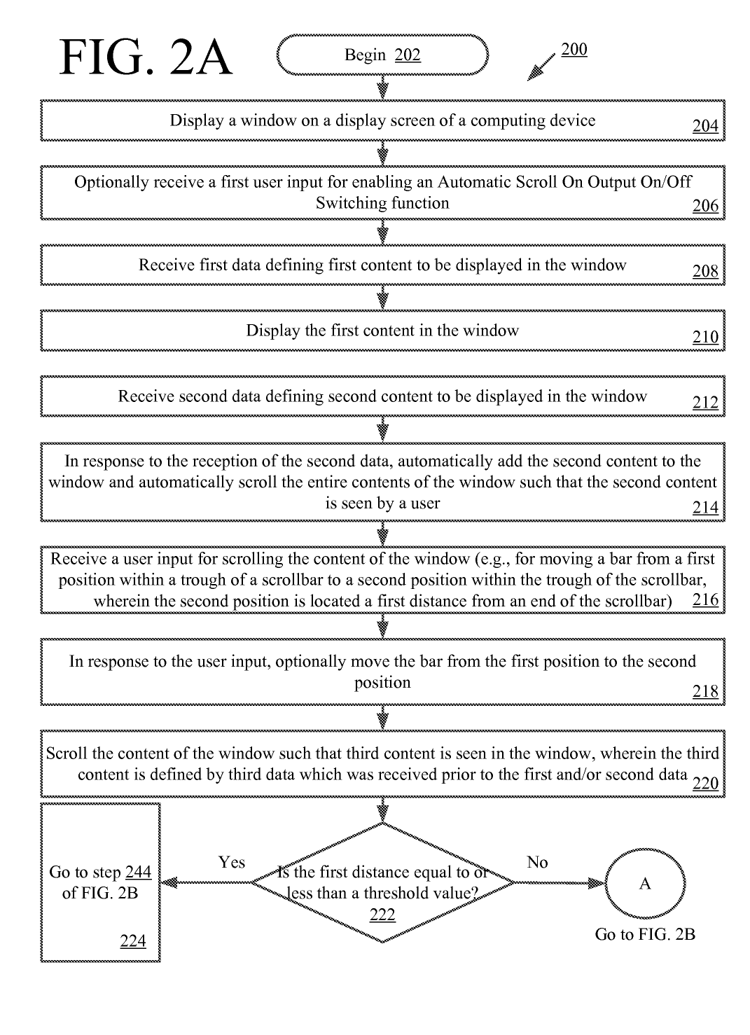

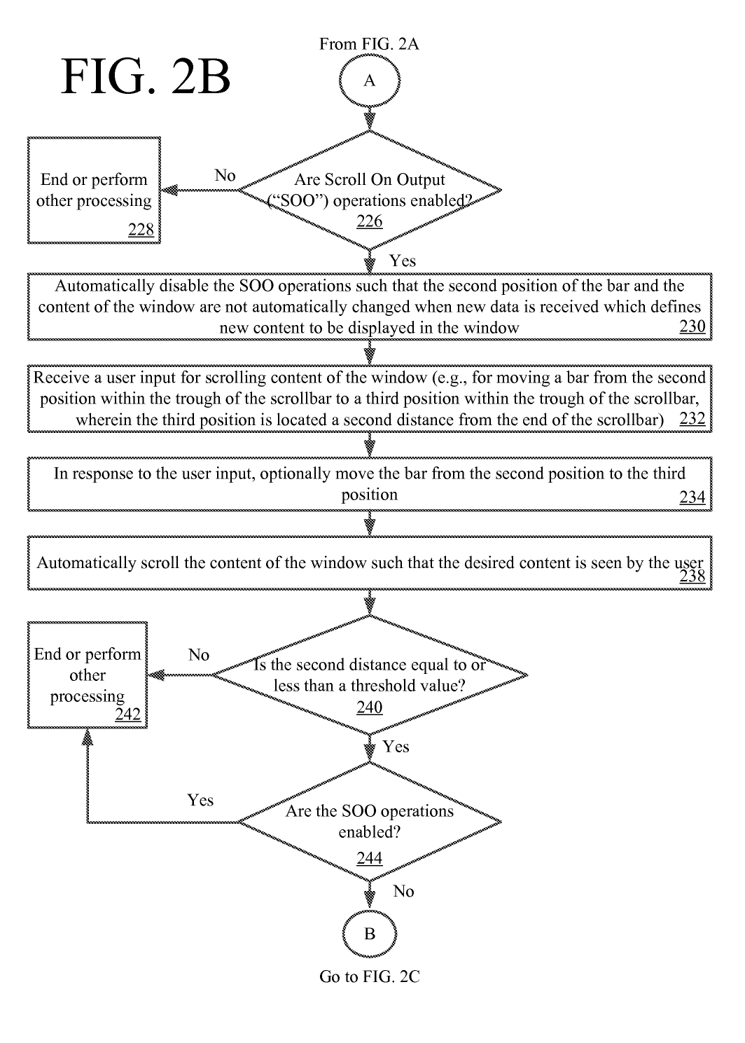

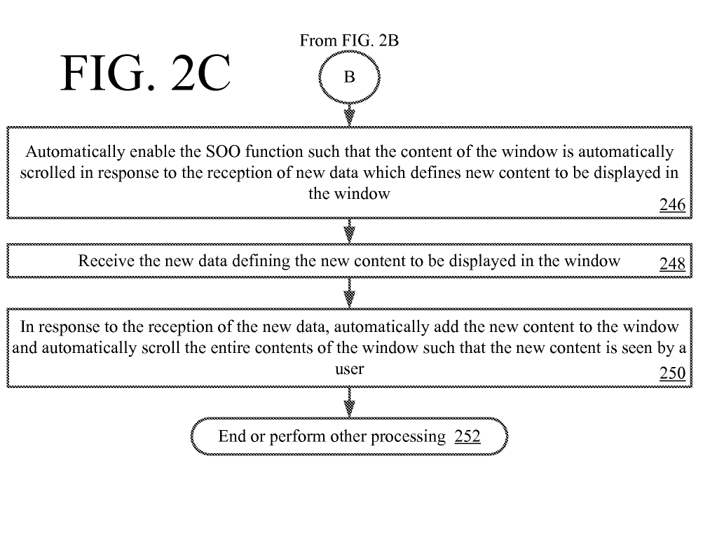

The present invention can be used in a variety of applications. Such applications include, but are not limited to, computer applications, test equipment applications, phone applications, instrument applications, electronic graphing applications, electronic charting application, calculator applications, media player applications, web-based applications, stock market applications and any other application in which an improved method is needed for changing a scroll-lock mode. The computers can include, but are not limited to, notebooks, desktop computers, laptop computers, personal digital assistants, tablet Personal Computers (“PCs”), and ipads. The test equipment can include, but is not limited to, oscilloscopes and spectrum analyzers. Exemplary implementing system embodiments of the present invention will be described below in relation to FIG. 1. Exemplary method embodiments of the present invention will be described below in relation to FIGS. 2A-11.

### Exemplary Systems Implementing the Present Invention

Referring now to FIG. 1, there is provided a block diagram of an exemplary Computing Device (“CD”) 100 that is useful for understanding the present invention. The CD 100 can include, but is not limited to, a notebook, a desktop computer, a laptop computer, a personal digital assistant, a tablet PC, an ipad, an oscilloscope, a spectrum analyzer and/or a graphing calculator. The CD 100 is generally configured to allow the scrolling of documents (e.g., data files, word processing documents, e-mail documents, images, and Internet web pages), video clips, messaging conversations and graphs. The scrolling involves the sliding of text, images or video across a monitor or display in the horizontal direction, the vertical direction, the diagonal direction, a multidimensional direction and/or a combination of said directions. Notably, the scrolling does not change the layout of the text, images, video or graphs, but incrementally moves the user's view across a larger document, list, image, video clip or graph that is not wholly seen in a computer display, window or viewport.

Manual scrolling is achieved using a scrollbar of a GUI, a scroll wheel of a computer mouse, a scroll ball of a computer mouse, arrow keys of a keyboard, a pointing device (e.g., a mouse pointer), a touch within a display area, gestures (e.g., body movements), and/or voice commands. Manual scrolling can be enabled and disabled by a user of CD 100 via a scroll lock key and/or a GUI element of a window. For example, a user enables or disables a “scroll-on keystroke” function of the CD 100 by depressing a scroll lock key of a keyboard, clicking on a symbol or text presented by a menu bar of an application window, and/or clicking on a checkbox associated with a caption (e.g., “Scroll-on keystroke”) presented by a configuration window. Embodiments of the present invention are not limited in this regard.

Automatic scrolling is achieved by enabling a “scroll-on output” mode of the CD 100. The “scroll-on output” mode can be manually enabled/disabled via a scroll lock key of a keyboard, a command presented within a menu of an application window, and/or the selection of a button (e.g., a checkbox) presented in a configuration window. The application window includes a menu bar. In contrast, the configuration window does not include a menu bar, but instead comprises a window with non-graphical menu based GUI elements for enabling/disabling one or more functions of the CD 100 and defining parameters of said functions. The configuration window can include, but is not limited to, a dialog box, an inspector window, and/or a palette window. The GUI elements include, but are not limited to, check boxes, combo boxes, scroll down lists, list boxes, scroll bars, text boxes, sliders, and/or spinners. The configuration window can also include one or more tabs. For example, a single tab can be provided for each of a plurality of different features of a display (e.g., colors, background and scrolling). In some embodiments of the present invention, the configurations widow is accessible via the menu bar of the application window or via a taskbar of a GUI desktop.

The “scroll-on output” mode is automatically enabled/disabled using a novel technique of the present invention. The novel technique will be described in detail below in relation to FIGS. 2A-11. Still, it should be understood that the novel technique generally involves: automatically switching “off” the “scroll-on output” mode when scrolling is used by a user to view a previous displayed output of the CD 100; and automatically switching “on” the “scroll-on output” mode when scrolling is used by the user to view the most recent displayed output of the CD 100.

Referring again to FIG. 1, the CD 100 comprises a system interface 122, a user interface 102, a Central Processing Unit (CPU) 106, a system bus 110, a memory 112 connected to and accessible by other portions of CD 100 through system bus 110, and hardware entities 114 connected to system bus 110. At least some of the hardware entities 114 perform actions involving access to and use of memory 112, which can be a Random Access Memory (RAM), a disk driver and/or a Compact Disc Read Only Memory (CD-ROM). Some or all listed components 102-122 can be implements as hardware, software and/or a combination of hardware and software. The hardware includes, but is not limited to, an electronic circuit.

The CD 100 may include more, less or different components than those illustrated in FIG. 1. However, the components shown are sufficient to disclose an illustrative embodiment implementing the present invention. The hardware architecture of FIG. 1 represents one embodiment of a representative computing device configured to facilitate the provision of an Automatic Scroll-On Output on/off Switching (“ASOOS”) function to a user thereof. As such, CD 100 implements a method for automatically switching “on” and “off” the “scroll-on output” mode in accordance with embodiments of the present invention.

Hardware entities 114 can include microprocessors, Application Specific Integrated Circuits (ASICs) and other hardware. Hardware entities 114 can include a microprocessor programmed for facilitating the provision of the ASOOS function to a user of the CD 100. In this regard, it should be understood that the microprocessor can access and run scrolling applications (not shown in FIG. 1) and other types of applications installed on the CD 100 (e.g., instant messaging applications, graphing applications, charting applications, e-book applications, e-mail applications, document applications, media applications, touch screen applications, voice command application and/or gesture command applications). The scrolling applications (not shown in FIG. 1) are operative to facilitate the provision of scrolling operations to a user of the CD 100. The scrolling operations include, but are not limited to, “scroll-on keystroke” operations, “mouse pointer scrolling” operations, “mouse wheel scrolling” operations, “mouse ball scrolling” operations, “scroll-on touch” operations, “scroll-on gesture” operations, “scroll-on voice command” operations, “scroll-on output” operations, and “ASOOS” operations.

The “scroll-on keystroke” operations involve scrolling the content of a computer display, window or viewport in response to the depression of a key (e.g., an arrow key) of a keyboard (not shown in FIG. 1). For example, the depression of the “up” or “left” arrow key of a keyboard causes the content of the computer display, window or viewport to be scrolled such that old data or previously displayed data is seen by a user of the CD 100. In contrast, the depression of the “down” or “right” arrow key of the keyboard causes the content of the computer display, window or viewport to be scrolled such that new data or recently displayed data is seen by the user of the CD 100. Embodiments of the present invention are not limited in this regard. In a waterfall display scenario, the depression of the “up” arrow key causes the content of the computer display, widow or viewport to be scrolled forwards, while the depression of the “down” arrow key causes the content to be scrolled backwards.

The “mouse pointer scrolling” operations involve scrolling the content of a computer display, window or viewport in response to the placement of a mouse pointer on a bar of a scrollbar and the movement of a mouse (not shown in FIG. 1) for dragging the bar from a first position within a trough of the scrollbar to a second position within the trough of the scrollbar. The “mouse pointer scrolling” operations also involve scrolling the content of a computer display, window or viewport in response to the placement of the mouse pointer on an arrow button of the scrollbar and clicking the arrow button. The “mouse wheel scrolling” operations and “mouse ball scrolling” operations involve scrolling the content of a computer display, window or viewport in response to the placement of a mouse pointer on a bar of a scrollbar and the movement of a mouse wheel or mouse ball for dragging the bar from a first position within a trough of the scrollbar to a second position within the trough of the scrollbar.

The “scroll-on touch” operations involve scrolling the content of a computer display, window or viewport in response to the touching of an icon, an image or a GUI widget (e.g., an arrow button) which is displayed on a display screen (not shown in FIG. 1). The “scroll-on gesture” operations involve scrolling the content of a computer display, window or viewport in response to a detection of a particular body movement. The body movement can be detected using a camera (not shown in FIG. 1) and body movement control software (not shown in FIG. 1) installed on the CD 100. The body movement can include, but is not limited to, a facial movement, an arm movement, a hand movement, a finger movement and a head movement.

The “scroll-on voice command” operations involve scrolling the content of a computer display, window or viewport in response to a detection of a voice command. The voice command can be detected using a microphone (not shown in FIG. 1) and voice command software (not shown in FIG. 1) installed on the CD 100.

The “scroll-on output” operations involve automatically scrolling the content of a computer display, window or viewport in response to the reception of new data to be displayed within the computer display, window or viewport. The “ASOOS” operations involve: automatically disabling the “scroll-on output” operations or switching “off” a “scroll-on output” mode when scrolling is used by a user to view a previously displayed output; and automatically enabling the “scroll-on output” operations or switching “on” the “scroll-on output” mode when scrolling is used by the user to view a most recently displayed output. The scrolling can be achieved in accordance with the previously described “scroll-on keystroke” operations, “mouse pointer scrolling” operations, “mouse wheel scrolling” operations, “mouse ball scrolling” operations, “scroll-on touch” operations, “scroll-on gesture” operations, and/or “scroll-on voice command” operations. The particularities of the “ASOOS” operations will become more apparent as the discussion progresses.

Notably, the enabling and disabling of software operations and/or functions are generally implemented using existing functions made available through an operating system or application. As such, the enabling and disabling of the “ASOOS” operations and “scroll-on output” operations can be implemented in accordance with any conventional method as would be known by persons skilled in the art. For example, the inventive arrangements could be implemented at the operating system level in which case operating system events would be performed in conjunction with operations performed by the software application facilitating the display of scrollable content. Alternatively, the inventive arrangements can be implemented at the application level in which case functions of one or more applications would be performed.

As shown in FIG. 1, the hardware entities 114 can include a disk drive unit 116 comprising a computer-readable storage medium 118 on which is stored one or more sets of instructions 120 (e.g., software code or code sections) configured to implement one or more of the methodologies, procedures, or functions described herein. The instructions 120 can also reside, completely or at least partially, within the memory 112 and/or within the CPU 106 during execution thereof by the CD 100. The memory 112 and the CPU 106 also can constitute machine-readable media. The term “machine-readable media”, as used here, refers to a single medium or multiple media (e.g., a centralized or distributed database, and/or associated caches and servers) that store the one or more sets of instructions 120. The term “machine-readable media”, as used here, also refers to any medium that is capable of storing, encoding or carrying a set of instructions 120 for execution by the CD 100 and that cause the CD 100 to perform any one or more of the methodologies of the present disclosure.

The user interface 102 includes, but is not limited to, a keyboard (not shown in FIG. 1), a mouse (not shown in FIG. 1), a display screen (not shown in FIG. 1), a microphone (not shown in FIG. 1), speakers (not shown in FIG. 1) and a camera (not shown in FIG. 1). The display screen can be designed to accept touch screen inputs. For example, a user can enable or disable the “ASOOS” operations by touching an icon, an image or a GUI widget (e.g., a button) which is displayed on the display screen. Embodiments of the present invention are not limited in this regard.

System interface 122 allows the CD 100 to communicate directly or indirectly with external communication devices (e.g., a server). If the CD 100 is communicating indirectly with the external communication device, then the CD 100 is sending and receiving communications through a common network (e.g., the Internet, the World Wide Web, or a Local Area Network).

As noted above, the CD 100 implements methods for automatically switching “on” and “off” a “scroll-on output” mode. Such methods will be described below in relation to FIGS. 2A-11.

### Exemplary Methods of the Present Invention

Referring now to FIGS. 2A-2C, there is provided a flow diagram of an exemplary method 200 for automatically switching “on” and “off” a “scroll-on output” mode or enabling and disabling “scroll-on output” operations. The method 200 will be described in an instant messaging context. The present invention is not limited in this regard. The method 200 is useful in other applications, such as graphing applications, charting applications, web page applications, e-book applications, document applications, video applications and any other application where content of a computer display, window or viewport can be scrolled.

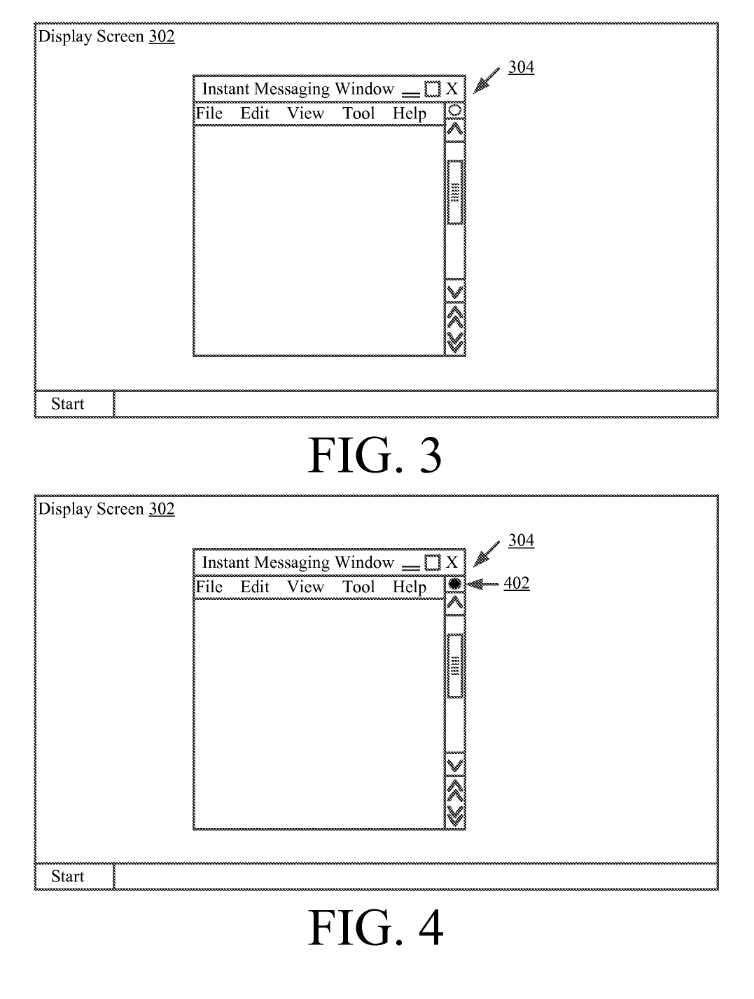

As shown in FIG. 2A, the method 200 begins with step 202 and continues with step 204. In step 204, a window is displayed on a display screen of a computing device (e.g., CD 100 of FIG. 1). A schematic illustration of an exemplary window 304 displayed on a display screen 302 is shown in FIG. 3. The window 304 includes an Instant Messaging Window (“IMW”). IMWs are well known in the art, and therefore will not be described herein. Embodiments of the present invention are not limited in this regard. The window 304 can include any type of window in accordance with a particular application. For example, the window 304 can alternatively include, but is not limited to, a graphing application window, an e-book application window or a media application window.

After completing step 204, the method 200 continues with an optional step 206. Optional step 206 involves receiving a first user input for enabling the ASOOS function of the computing device. In some embodiments of the present invention, the ASOOS function can be enabled via a GUI widget of an application window, a menu of the application window and/or a GUI widget of a configuration window. A schematic illustration of an exemplary GUI widget 402 of an application window 304 is shown in FIG. 4. The GUI widget 402 can include, but is not limited to, a button. The provision of such a GUI widget 402 has certain advantages. For example, a user of the computing device does not need to navigate to a menu or configuration window to change the scrolling behaviors of the computing device.

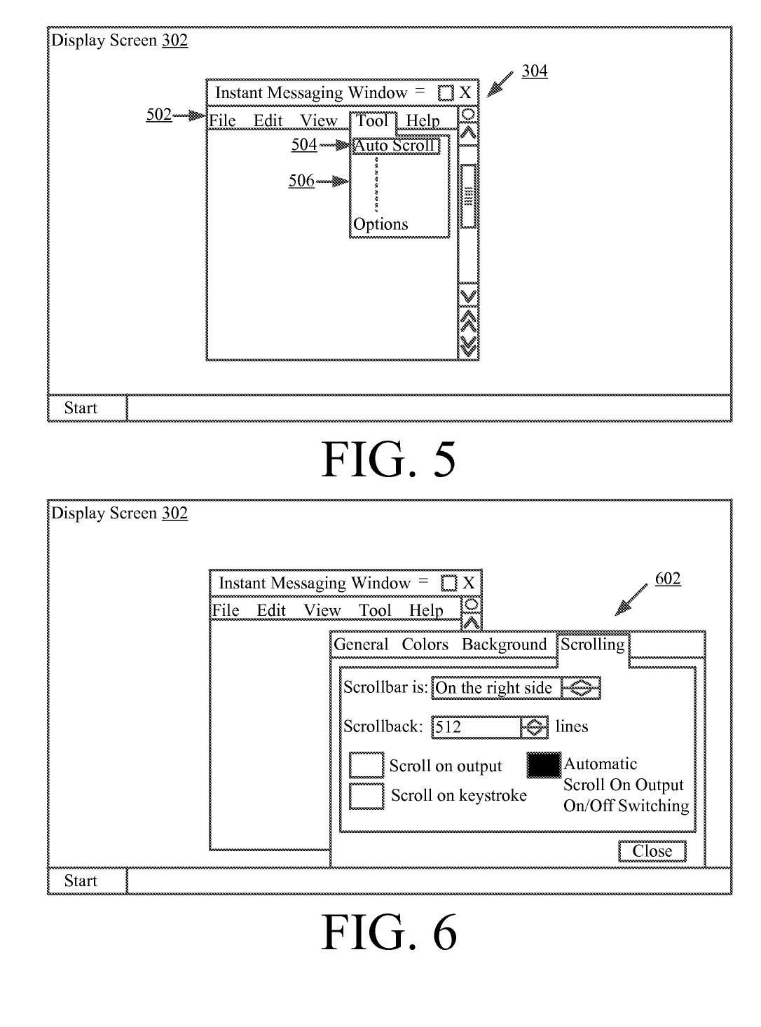

A schematic illustration of an exemplary menu 506 which facilitates the enablement/disablement of the ASOOS function is provided in FIG. 5. As shown in FIG. 5, a user of the computing device can enable/disable the ASOOS function by clicking on the caption “Auto Scroll” 504 in the list of commands of the menu 506.

A schematic illustration of an exemplary configuration window 602 which facilitates the enablement/disablement of the ASOOS function is provided in FIG. 6. As shown in FIG. 6, the configuration window 602 includes a plurality of tabs. One of the tabs is a “Scrolling” tab having GUI widgets for defining parameters for scrolling operations of the computing device (e.g., scrollbar location and number of scrollback lines), enabling/disabling “scroll-on output” operations, enabling/disabling “scroll-on keystroke” operations, and enabling/disabling “ASOOS” operations.

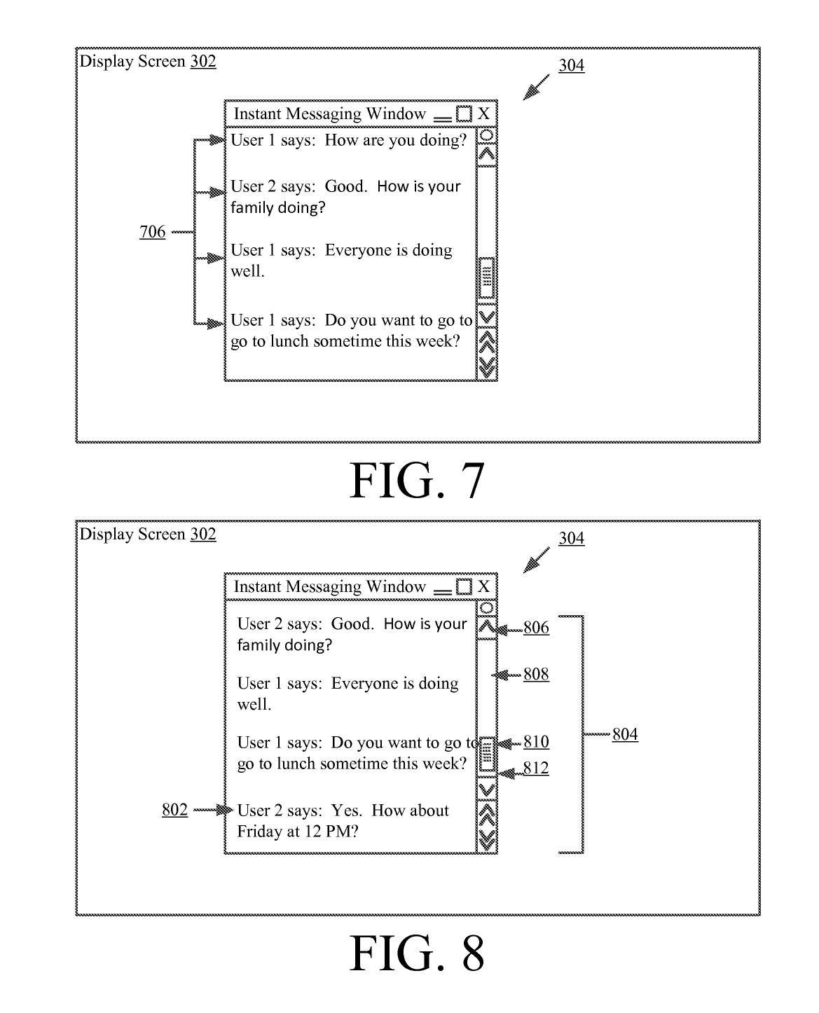

Referring again to FIG. 2A, the method 200 continues with step 208 where first data is received at the computing device. The first data defines first content to be displayed in the window (e.g., IMW 304 of FIG. 3). In a next step 210, the first content is displayed in the window (e.g., IMW 304 of FIG. 3). A schematic illustration of exemplary first content 706 displayed in the window 304 of FIG. 3 is provided in FIG. 7. The first content 706 includes all of the statements made by two people participating in an instant messaging conversation up until the current period of time.

Upon completing step 210, step 212 is performed where second data is received. The second data defines second content to be displayed in the window (e.g., IMW of FIG. 3) which is different than the first content. In response to the reception of the second data, the second content is automatically added to the window content, as shown by step 214. Also, the entire content of the window (e.g., IMW 304 of FIG. 3) is automatically scrolled such that the second content is seen by a user of the computing device, as also shown by step 214. A schematic illustration of exemplary second content 802 added to the window 304 of FIG. 3 is provided in FIG. 8. As shown in FIG. 8, the entire content of the window 304 has been scrolled such that the second content 802 is seen by a user of the computing device. The second content 802 includes the most recent instant messaging output of the computing device. For example, the second content 802 includes the last statement made by one of the people participating in the instant messaging conversation. As also shown in FIG. 8, a bar 810 of a scrollbar 804 is located near an end of a trough 808 thereof. The importance of the bar's 810 position within the trough 808 will become more evident as the discussion progresses.

Referring again to FIG. 2A, the method 200 continues with step 216 where a user input for scrolling the content of the window is received. In some embodiments of the present invention, the user input is an input for moving a bar from a first position within a trough of a scrollbar to a second position within the trough of the scrollbar. The user input can include, but is not limited to, the dragging of the bar within the trough, the clicking on an arrow button of the scrollbar, the touching of the arrow button of the scrollbar, a depression of a key on a keyboard, a voice command or a gesture command. In response to the reception of the user input, steps 218 and 220 are performed. Notably, step 218 is an optional step. If the method 200 includes optional step 218, then steps 218 and 220 can be performed simultaneously, concurrently or sequentially (as shown in FIG. 2A).

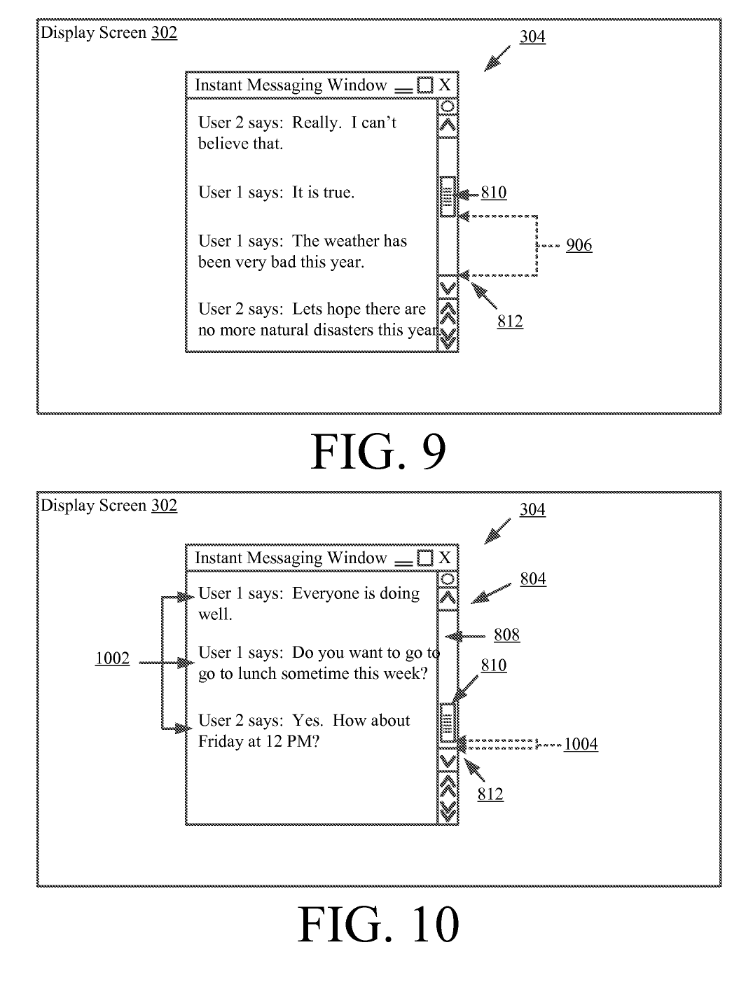

Optional step 218 involves moving a bar of a scrollbar from a first position to a second position with a trough of the scrollbar. The second position is located a first distance from an end of the scrollbar or end of a trough of the scrollbar. A schematic illustration of a bar 810 in a first position is shown in FIG. 8. The first position is near or adjacent to an end 812 of the trough 808 of the scrollbar 804. A schematic illustration of the bar 810 in a second position is shown in FIG. 9. The bar 810 has been moved from its first position to its second position by a user software interaction involving clicking on arrow button 806 of the scrollbar 804 or by dragging the bar 810 within the trough 808 of the scrollbar 804. The second position is located a distance 906 away from the end 812 of the trough 808.

Referring again to FIG. 2, step 220 involves automatically scrolling the content of the window such that third content is seen by a user of the computing device. The third content is defined by third data which was received prior to the first data and/or second data. A schematic illustration of exemplary third content 904 is provided in FIG. 9. As shown in FIG. 9, the third content 904 includes previous statements made by the people participating in the instant messaging conversation during a period of time which is earlier than the current period of time.

Next, a decision step 222 is performed to determine if the first distance (e.g., distance 906 of FIG. 9) is equal to or less than a threshold value. If the first distance is equal to or less than the threshold value [222:YES], then step 224 is performed where the method 200 goes to step 244 of FIG. 2B. Step 244 of FIG. 2B will be described below. If the first distance is not equal to or less than the threshold value [222:NO], then the method 200 continues with a decision step 226 of FIG. 2B.

Decision step 226 of FIG. 2B is performed to determine if “scroll-on output” operations are enabled. If the “scroll-on output” operations are not enabled [226:NO], then step 228 is performed where the method 200 ends of other processing is performed. If the “scroll-on output” operations are enabled [226:YES], then step 230 is performed. Step 230 involves automatically disabling the “scroll-on output” operations. By disabling the “scroll-on output” operations, the second position of the bar and the content of the window will not be automatically changed when new data is received by the computing device. The new data defines new content to be displayed in the window.

Upon completing step 230, step 232 is performed where a user input for scrolling content of the window is received at the computing device. In some embodiments of the present invention, the user input comprises moving the bar from the second position to a third position within the trough of the scrollbar. The user input can include, but is not limited to, the dragging of the bar within the trough, the clicking on an arrow button of the scrollbar, the touching of the arrow button of the scrollbar, a depression of a key on a keyboard, a voice command or a gesture command. In response to the user input, steps 234 and 238 are performed. Notably, step 234 is an optional step. If the method 200 includes optional step 234, then steps 234 and 238 can be performed simultaneously, concurrently or sequentially (as shown in FIG. 2B).

In optional step 234, the bar is moved from the second position to the third position. The third position is located a second distance from the end of the trough of the scrollbar. A schematic illustration of the bar 810 in an exemplary third position is provided in FIG. 10. As shown in FIG. 10, the bar 810 is located a distance 1004 from the end 812 of the trough 808 of the scrollbar 804. The distance 1004 is less than the distance 906.

Referring again to FIG. 2B, step 238 involves automatically scrolling the content of the window such the desired content is seen by the user. A schematic illustration of exemplary desired content 1002 is provided in FIG. 10. As shown in FIG. 10, the desired content 1002 includes the latest statements made by the people participating in the instant messaging conversation up until the current period of time.

Upon completing step 238, a decision step 240 is performed to determine if the second distance is equal to or less than a threshold value. The threshold value can be the same as or different than the threshold value used in previous step 222 of FIG. 2A. If the second distance is not equal to or less than the threshold value [240:NO], then step 242 is performed where the method 200 ends or other processing is performed. If the second distance is equal to or less than the threshold value [240:YES], then a decision step 244 is performed. In decision step 244, a decision is made as to whether or not the “scroll-on output” operations are enabled. If the “scroll-on output” operations are enabled [244:YES], then step 242 is performed. If the “scroll-on output” operations are not enabled [244:NO], then step 246 of FIG. 2C is performed where the “scroll-on output” operations are automatically enabled. By enabling the “scroll-on output” operations, the content of the window will be automatically scrolled in response to the reception of new data which defines new content to be displayed in the window.

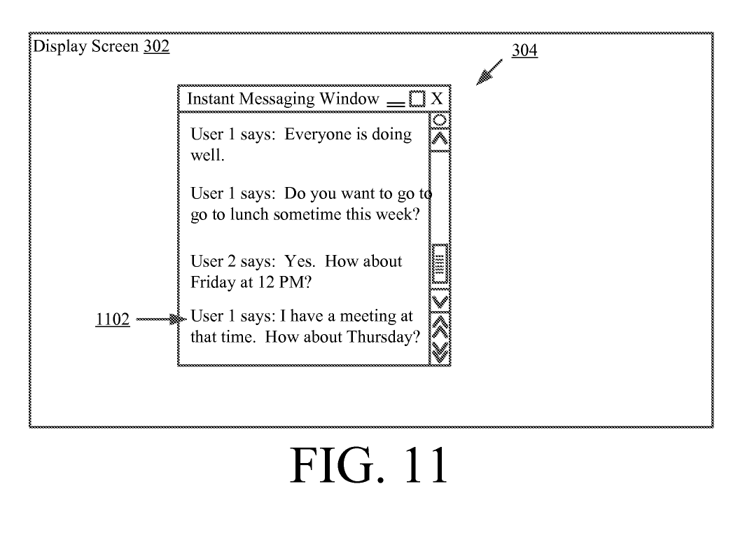

In a next step 248, the new data is received at or by the computing device. In response to the reception of the new data, step 250 is performed where the new content is automatically added to the window. Also in step 250, the entire content of the window is automatically scrolled such that the new content is seen by the user. A schematic illustration of exemplary new content 1102 being displayed in the window 304 of FIG. 3 is provided in FIG. 11. As shown in FIG. 11, the new content 1102 includes the most recent statements made by a person participating in the instant messaging conversation. Subsequent to the completion of step 250, step 252 is performed where the method 200 ends or other processing is performed.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for automatically controlling “scroll-on output” operations of a computing device, comprising:
adding, by said computing device, first display content to a display thereof;
receiving, by said computing device, a first user input for scrolling back said first display content so as to be able to view a first portion of said first display content which is not currently visible within said display and was previously displayed in said display;
in response to the reception of said first user input, performing the following operations
determining if said “scroll-on output” operations are enabled, and
automatically disabling said “scroll-on output” operations if it is determined that said “scroll-on output” operations are enabled.

2. The method according to claim 1, wherein said first user input comprises a voice command, a gesture command, a user input that causes an actuation of a virtual button, or a user input that causes an actuation of a scrollbar.

3. The method according to claim 1, further comprising:
receiving, by said computing device, a second user input for scrolling forward said first display content so as to be able to view a second portion of said first display content which is not currently visible within said display;
in response to the reception of said second user input, performing the following operations
determining if said “scroll-on output” operations are enabled, and
automatically enabling said “scroll-on output” operations if it is determined that said “scroll-on output” operations are not enabled.

4. The method according to claim 3, wherein said second user input comprises a voice command, a gesture command, a user input that causes an actuation of a virtual button, or a user input that causes an actuation of a scrollbar.

5. The method according to claim 1, further comprising receiving, by said computing device, a second user input for enabling automatic “scroll-on output” mode on/off switching operations, said second user input causing actuation of a virtual button displayed in an application window.

6. A method for controlling “scroll-on output” operations of a computing device, comprising:
receiving, by said computing device, a first user input for moving a bar from a first position within a trough of a scrollbar to a second position within said trough of said scrollbar, wherein said bar is a first distance from an end of said scrollbar when it is in said first position and a second distance from said end of said scrollbar when it is in said second position, said second distance being greater than said first distance;
in response to the reception of said first user input, performing the following operations
comparing said second distance to a threshold value,
automatically disabling said “scroll-on output” operations if said “scroll-on output” operations are currently enabled and a result of said comparing operation indicates that said second distance is greater than said threshold value, and
automatically enabling said “scroll-on output” operations if said “scroll-on output” operations are currently disabled and a result of said comparing operation indicates that said second distance is equal to or less than said threshold value.

7. The method according to claim 6, wherein said first user input comprises a voice command, a gesture command, a user input that causes an actuation of a virtual button, or a user input that causes an actuation of a scrollbar.

8. The method according to claim 6, further comprising receiving, by said computing device, a second user input for enabling automatic “scroll-on output” mode on/off switching operations, said second user input causing actuation of a virtual button displayed in an application window.

9. A system for automatically controlling “scroll-on output” operations of a computing device, comprising:
at least one electronic circuit configured to
add first display content to a display of said computing device,
receive a first user input for scrolling back said first display content so as to be able to view a first portion of said first display content which is not currently visible within said display and was previously displayed in said display, and
perform the following operations in response to the reception of said first user input
determining if said “scroll-on output” operations are enabled, and
automatically disabling said “scroll-on output” operations if it is determined that said “scroll-on output” operations are enabled.

10. The system according to claim 9, wherein said electronic circuit is configured to receive said first user input in the form of a voice command, a gesture command, an actuation of a virtual button, or an actuation of a scrollbar.

11. The system according to claim 9, wherein said electronic circuit is further configured to
receive a second user input for scrolling forward said first display content so as to be able to view a second portion of said first display content which is not currently visible within said display, and
in response to the reception of said second user input, performing the following operations
determining if said “scroll-on output” operations are enabled, and
automatically enabling said “scroll-on output” operations if it is determined that said “scroll-on output” operations are not enabled.

12. The system according to claim 11, wherein said second user input comprises a voice command, a gesture command, a user input that causes an actuation of a virtual button, or a user input that causes an actuation of a scrollbar.

13. The system according to claim 9, wherein said electronic circuit is further configured to receive a second user input for enabling automatic “scroll-on output” mode on/off switching operations, said second user input causing actuation of a virtual button displayed in an application window.

14. A system for controlling “scroll-on output” operations of a computing device, comprising:
at least one electronic circuit configured to
receive a first user input for moving a bar from a first position within a trough of a scrollbar to a second position within said trough of said scrollbar, wherein said bar is a first distance from an end of said scrollbar when said bar is in said first position and a second distance from said end of said scrollbar when said bar is in said second position, said second distance being greater than said first distance, and
perform the following operations in response to the reception of said first user input
comparing said second distance to a threshold value,
automatically disabling said “scroll-on output” operations if said “scroll-on output” operations are currently enabled and a result of said comparing operation indicates that said second distance is greater than said threshold value, and
automatically enabling said “scroll-on output” operations if said “scroll-on output” operations are currently disabled and a result of said comparing operation indicates that said second distance is equal to or less than said threshold value.

15. The system according to claim 14, wherein said first user input comprises a voice command, a gesture command, a user input that causes an actuation of a virtual button, or a user input that causes an actuation of a scrollbar.

16. The system according to claim 14, wherein said electronic circuit is further configured to receive a second user input for enabling automatic “scroll-on output” mode on/off switching operations, said second user input causing actuation of a virtual button displayed in an application window.

17. A device comprising a computer-readable storage medium, having stored thereon a computer program for controlling “scroll-on output” operations, the computer program having a plurality of code sections, the code sections executable by a computer to cause the computer to perform the steps of:
adding first display content to a display;
receiving a first user input for scrolling back said first display content so as to be able to view a first portion of said first display content which is not currently visible within said display and was previously displayed in said display;
in response to the reception of said first user input, performing the following operations
determining if said “scroll-on output” operations are enabled, and
automatically disabling said “scroll-on output” operations if it is determined that said “scroll-on output” operations are enabled.

18. The device according to claim 17, wherein said first user input comprises a voice command, a gesture command, a user input that causes an actuation of a virtual button, or a user input that causes an actuation of a scrollbar.

19. The device according to claim 17, further comprising code sections for causing the computer to perform the steps of:
receiving a second user input for scrolling forward said first display content so as to be able to view a second portion of said first display content which is not currently visible within said display;
in response to the reception of said second user input, performing the following operations
determining if said “scroll-on output” operations are enabled, and
automatically enabling said “scroll-on output” operations if it is determined that said “scroll-on output” operations are not enabled.

20. The device according to claim 19, wherein said second user input comprises a voice command, a gesture command, a user input that causes an actuation of a virtual button, or a user input that causes an actuation of a scrollbar.

21. The device according to claim 17, further comprising code sections for causing the computer to perform the step of receiving a second user input for enabling automatic “scroll-on output” mode on/off switching operations, said second user input causing actuation of a virtual button displayed in an application window.

22. A device comprising a computer-readable storage medium, having stored thereon a computer program for controlling “scroll-on output” operations, the computer program having a plurality of code sections, the code sections executable by a computer to cause the computer to perform the steps of:
receiving a first user input for moving a bar from a first position within a trough of a scrollbar to a second position within said trough of said scrollbar, wherein said bar is a first distance from an end of said scrollbar when it is in said first position and a second distance from said end of said scrollbar when it is in said second position, said second distance being greater than said first distance; and
in response to the reception of said first user input, performing the following operations
comparing said second distance to a threshold value,
automatically disabling said “scroll-on output” operations if said “scroll-on output” operations are currently enabled and a result of said comparing operation indicates that said second distance is greater than said threshold value, and
automatically enabling said “scroll-on output” operations if said “scroll-on output” operations are currently disabled and a result of said comparing operation indicates that said second distance is equal to or less than said threshold value.

23. The device according to claim 22, wherein said first user input comprises a voice command, a gesture command, a user input that causes an actuation of a virtual button, or a user input that causes an actuation of a scrollbar.

24. The device according to claim 22, further comprising code sections for causing the computer to perform the step of receiving a second user input for enabling automatic “scroll-on output” mode on/off switching operations, said second user input causing actuation of a virtual button displayed in an application window.
